(19) United States
(12) Patent Application Publication
(10) Pub. No.: US 2015/0379460 A1
(43) Pub. Date: Dec. 31, 2015

(54) RECOGNIZING NEGLECTED ITEMS

(71) Applicant: Kamal Zamer, Austin, TX (US)

(72) Inventor: Kamal Zamer, Austin, TX (US)

(21) Appl. No.: 14/317,787

(22) Filed: Jun. 27, 2014

(51) Int. Cl. G06Q 10/08; G06Q 30/06

(52) U.S. Cl. CPC G06Q 10/087; G06Q 30/0601

(57) ABSTRACT

A system and method of recognizing neglected items are disclosed. In some embodiments, a first item of a first user is identified as being neglected based on a determination of a lack of usage of the first item. A notification can then be provided to the first user based on the identifying of the first item as being neglected. The notification can comprise an identification of the first item. The notification can further comprise a recommendation to list the first item for sale on an online service. In some embodiments, item listing information for the first item can be determined, and at least one item listing field can be pre-populated using the determined item listing information. The pre-populated item listing field(s) can be provided to the first user for listing the first item for sale.

### TECHNICAL FIELD

The present application relates generally to the technical field of search query processing, and, in various embodiments, to systems and methods of recognizing neglected items.

### BACKGROUND

Over time, a person can acquire many different items. At a certain point, the person may stop using an item due to a lack of interest in the item, the replacement of the item with another item, or a variety of other reasons. As a result, such items often become neglected, and simply remain in the user's possession without being used or sold.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publisher, in accordance with some embodiments;

FIG. 3 is a block diagram depicting various tables that may be maintained within a database, in accordance with some embodiments;

FIG. 4 is a block diagram illustrating a neglected item system, in accordance with some embodiments;

FIG. 5 illustrates an environment in which a neglected item system can be employed, in accordance with some embodiments;

FIG. 6A illustrates a screen displaying a notification regarding a neglected item, in accordance with some embodiments;

FIG. 6B illustrates a screen displaying a notification regarding a neglected item, in accordance with some embodiments;

FIG. 6C illustrates a screen displaying a notification regarding a neglected item, in accordance with some embodiments;

FIG. 6D illustrates a screen displaying pre-populated item listing fields, in accordance with some embodiments;

FIG. 7 is a flowchart illustrating a method of recognizing neglected items, in accordance with some embodiments;

FIG. 8 is a flowchart illustrating a method of managing an item inventory of a user, in accordance with some embodiments;

FIG. 9 is a flowchart illustrating a method of determining a lack of usage of an item, in accordance with some embodiments;

FIG. 10 is a flowchart illustrating a method of determining a lack of usage of an item, in accordance with some embodiments;

FIG. 11 is a flowchart illustrating a method of determining a lack of usage of an item, in accordance with some embodiments;

FIG. 12 is a flowchart illustrating a method of determining a lack of usage of an item, in accordance with some embodiments;

FIG. 13 is a flowchart illustrating a method of determining a lack of usage of an item, in accordance with some embodiments;

FIG. 14 is a flowchart illustrating a method of providing one or more pre-populated item listing fields for listing a neglected item for sale, in accordance with some embodiments;

FIG. 15 is a block diagram illustrating a mobile device, in accordance with some example embodiments; and

FIG. 16 shows a diagrammatic representation of a machine in the example form of a computer system within which a set of instructions may be executed to cause the machine to perform any one or more of the methodologies discussed herein, in accordance with some example embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure provides systems and methods of recognizing neglected items. A user can be notified of a neglected item and can be prompted to take further actions regarding the item, such as selling the item on an online marketplace.

In some embodiments, a first item of a first user is identified as being neglected based on a determination of a lack of usage of the first item, and a notification is provided to the first user based on the identifying of the first item as being neglected. The notification can comprise an identification of the first item. In some embodiments, the first item is an electronic device.

In some embodiments, the lack of usage of the first item is determined based on a determination that the first item has not been located within a specified proximity of a master item for a predetermined period of time. In some embodiments, the lack of usage of the first item is determined based on a determination that the first item has remained in a location for a predetermined period of time. In some embodiments, the lack of usage of the first item is determined based on a determination that the first item has been in a non-operational mode for a predetermined period of time. The non-operational mode can comprise an energy-saving mode or a power-off mode. In some embodiments, the lack of usage of the first item can be determined based on a determination that the first item has not performed a user-requested task for a predetermined period of time.

In some embodiments, the determination of the lack of usage of the first item is based on a comparison of usage information of the first item with usage information of at least one other item of at least one other user. In some embodiments, the other item(s) is/are determined to meet a predetermined threshold of similarity with the first item. In some embodiments, the other user(s) is/are determined to meet a predetermined threshold of similarity with the first user.

In some embodiments, the notification further comprises a recommendation to list the first item for sale on an online service. In some embodiments, item listing information can be determined for the first item, and at least one item listing field can be pre-populated using the determined item listing information. The pre-populated item listing field(s) can then be provided to the first user for listing the first item for sale. In some embodiments, the item listing information is determined based on point of sale data for the first item. In some embodiments, the item listing information is determined based on corresponding item listing information of at least one other item. The other item(s) can comprise an identical product as the first item. In some embodiments, the item listing information comprises at least one of an item listing title, an item listing description, and an item listing price.

In some embodiments, an item inventory of the first user is managed. The item inventory can comprise a plurality of user items including the first item. For each user item in the item inventory, it can be determined whether the user item is being neglected based on a determination of a lack of usage of the user item. For each user item determined to be neglected, a notification of the user item being neglected can be provided to the first user. The notification can comprise an identification of the user item. In some embodiments, managing the item inventory comprises receiving an indication of an acquisition of a second item by the first user, and adding the second item to the item inventory. In some embodiments, receiving the indication comprises receiving purchase data of the second item. In some embodiments, receiving the indication comprises detecting a use of the second item in association with the first user.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

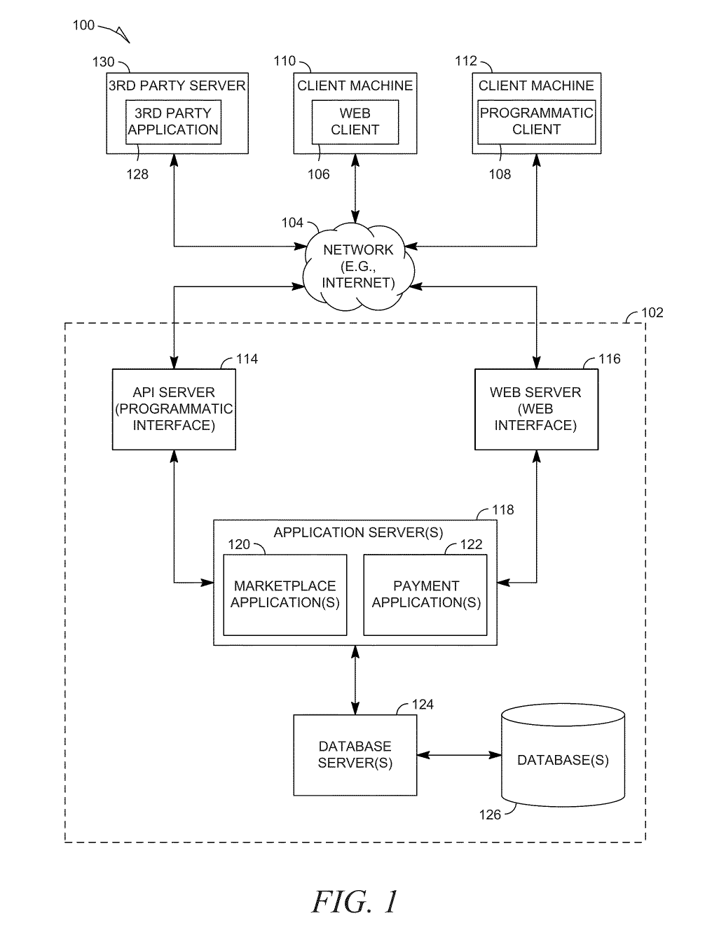

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

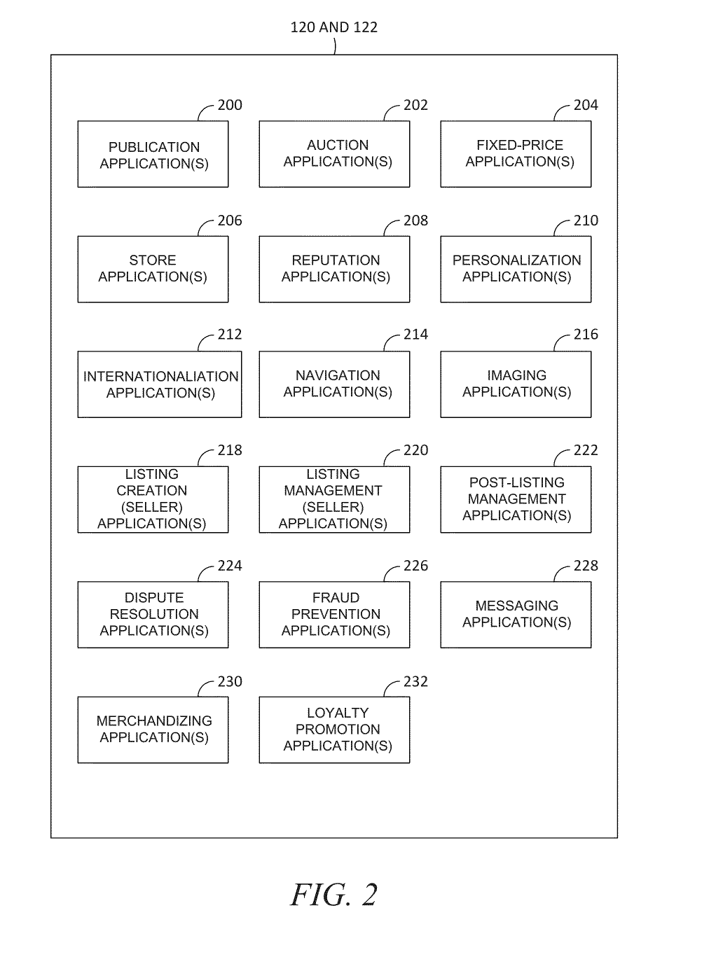

FIG. 2 is a block diagram illustrating multiple marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may, furthermore, access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page on which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make the listings available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

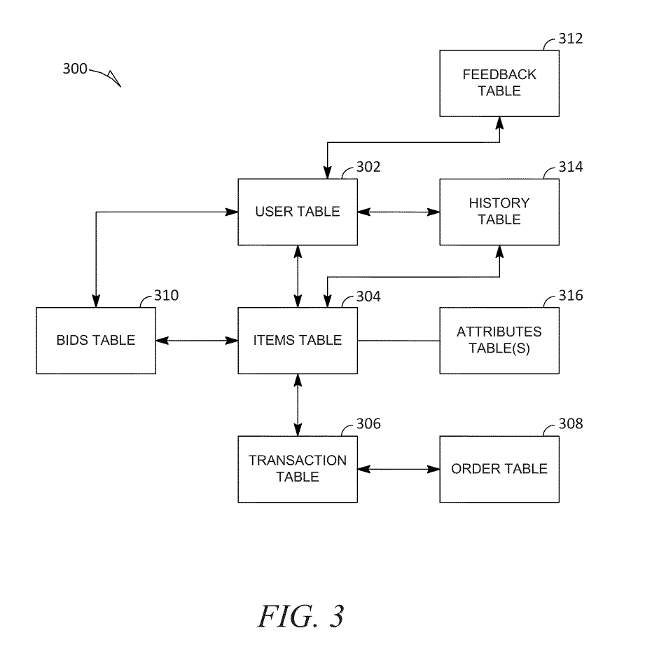

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, the currency attribute identifying the currency of a price for the relevant item as specified by a seller.

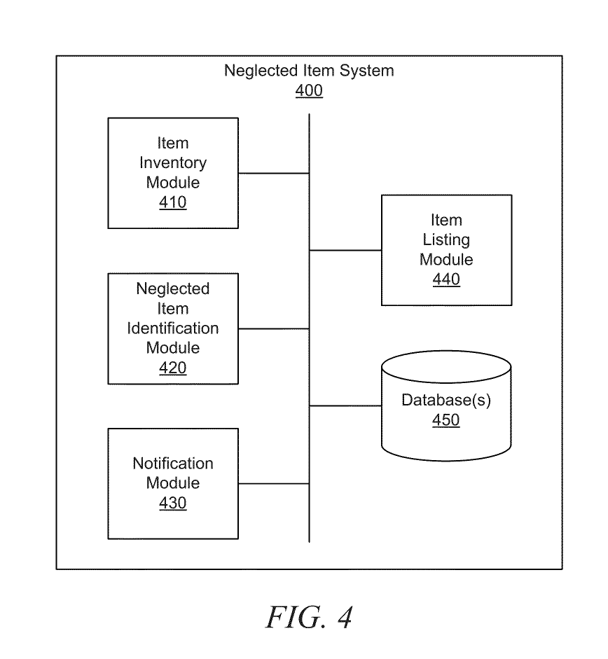

FIG. 4 is a block diagram illustrating a neglected item system 400, in accordance with some embodiments. In some embodiments, neglected item system 400 comprises an item inventory module 410, a neglected item identification module 420, a notification module 430, an item listing module 440, and one or more databases 450. In some embodiments, any combination of one or more of the modules, databases, or other components of neglected item system 400 can be incorporated into a machine, device, or system of a user (e.g., client machine 110 or 112 in FIG. 1). For example, the features disclosed herein can be implemented, at least partially, by a software application residing on a mobile device (e.g., a smartphone) of a user. In some embodiments, any combination of one or more of the modules, databases, or other components of neglected item system 400 can be incorporated into a machine, device, or system of an entity other than the user. For example, the features disclosed herein can be implemented, at least partially, by an online service (e.g., an online service residing within networked system 102 in FIG. 1). The modules 410, 420, 430, and 440 of neglected item system 400 can reside on application server(s) 118 in FIG. 1, and the database(s) 450 can be incorporated into database(s) 126 in FIG. 1. In some embodiments, some modules, databases, and/or other components of neglected item system 400 can reside on a machine, device, or system of a user, while other modules, databases, and/or other components of neglected item system 400 can reside on a machine, device, or system of an entity other than the user. Other configurations are also within the scope of the present disclosure.

Any of the communication described herein between any of the systems, devices, databases, modules, services, and websites can be achieved via one or more networks (e.g., network 104 in FIG. 1). The network(s) may include any network that enables communication between or among modules, machines, databases, devices, and any other components capable of communicating with other components. Accordingly, the network(s) may include a wired network, a wireless network (e.g., a mobile or cellular network), or any suitable combination thereof. The network(s) may include one or more portions that constitute a private network, a public network (e.g., the Internet), or any suitable combination thereof. Other configurations are also within the scope of the present disclosure.

The neglected item system 400 can be configured to provide a service that is able to understand which items (e.g., devices or products) a user has not used in some time, notify the user of this lack of use, and recommend that these items be listed for sale, such as on an online marketplace. This service can eliminate the burden of the user manually recognizing a neglected (e.g., forgotten) item, as well as eliminate the burden of the user determining and entering the appropriate item listing information when going through a listing creation process for listing the neglected item for sale.

Item inventory module 410 can be configured to manage an item inventory of a user. The item inventory can comprise a record of items of the user. For example, as the user acquires (e.g., purchases) items, these items can be added to the item inventory of the user. As the user relinquishes possession of (e.g., sells) items, these items can be removed from the item inventory of the user. In some embodiments, a user can acquire an item by purchasing the item. However, other forms of acquiring items are also within the scope of the present disclosure. In some embodiments, a user can relinquish possession of an item by selling the item. However, other forms of relinquishing possession of items are also within the scope of the present disclosure. The item inventory of a user can be stored in database(s) 450.

Indications and information of item acquisitions and relinquishments can be obtained in a variety of ways. In some embodiments, the item inventory module 410 can receive indications and information of a user's item acquisitions and/or relinquishments from one or more online marketplace accounts of the user (e.g., the user's eBay.com® account or Amazon.com® account). For example, the item inventory module 410 can access the user's purchase history and/or selling history associated with the user's online marketplace account(s) to determine what items the user has acquired and/or relinquished.

In some embodiments, the item inventory module 410 can receive indications and information of a user's item acquisitions and/or relinquishments from one or more online payment service accounts (e.g., PayPal®) and/or financial service accounts (e.g., Bank of America®) of the user. For example, the item inventory module 410 can access transaction information processed by any of these accounts to determine what items the user has acquired and/or relinquished.

In some embodiments, the item inventory module 410 can receive indications and information of a user's item acquisitions and/or relinquishments from one or more service providers associated with one or more of the user's items (e.g., Sprint® providing wireless communication services for the user's new cell phone). For example, the item inventory module 410 can receive information (e.g., notification of service beginning for a new item, notification of termination of service for an old item) from these service providers to determine what items the user has acquired and/or relinquished, such as with a new smartphone replacing a user's existing smartphone (e.g., the phone number of the existing smartphone being transferred to the new smartphone).

In some embodiments, the item inventory module 410 can receive indications and information of a user's item acquisitions and/or relinquishments from electronic messages sent to or from the user. For example, the item inventory module 410 can access the user's e-mail messages (e.g., via the user's e-mail account) and/or the user's text messages (e.g., via the user's wireless communication service account) to retrieve information (e.g., receipts, notifications, confirmations, etc.) indicating what items the user has acquired and/or relinquished.

In some embodiments, the item inventory module 410 can receive indications and information of a user's item acquisitions and/or relinquishments directly from the user or from another person on the user's behalf. For example, the item inventory module 410 can provide a user interface with which a user can submit information indicating what items the user has acquired and/or relinquished.

In some embodiments, the item inventory module 410 can receive indications and information of a user's item acquisitions and/or relinquishments by detecting an item or a use of an item. For example, the presence of an item or a user of an item can be detected via network communication involving the item, such as a printer being added to a user's home network. The item inventory module 410 can be in communication with one or more networks used by the user and monitor activity on the network(s) involving any items of the user.

It is contemplated that other ways of obtaining indications and information of item acquisitions and relinquishments of a user are also within the scope of the present disclosure.

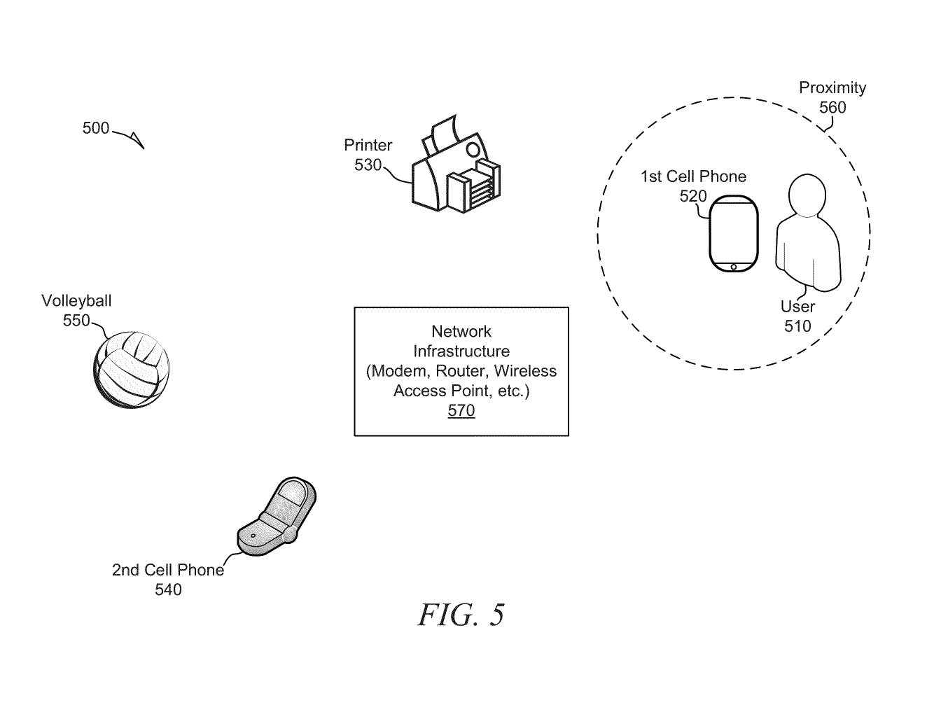

FIG. 5 illustrates an environment 500 in which neglected item system 400 can be employed, in accordance with some embodiments. In FIG. 5, a user 510 can have a variety of items, such as a first cell phone 520, a printer 530, a second cell phone 540, and a volleyball 550. Some of these items (e.g., first cell phone 520, printer 530, and second cell phone 540) can be electronic items, while other items (e.g., volleyball 550) can be non-electronic items. The user 510 can use a network infrastructure 570 (e.g., a modem, a router, a wireless access point, etc.) to communicate to and via items within a certain location (e.g., within the home of the user 510). For example, the user 510 can submit a request from a laptop (not shown) to the printer 530 via the network infrastructure 570 to print a document. Items can also be communicated with via peer-to-peer communication (e.g., near field communication or Bluetooth® communication between the first cell phone 520 and the printer 530). Other forms of communication to, from, and between items are also within the scope of the present disclosure.

In some embodiments, one or more of the items of the user 510 can be used as a master item. The term “master” is not used herein to imply a controlling role (i.e., a master of a master/slave paradigm), but rather to identify one or more items that serves as a monitor or administrator of the use of items in the item inventory of the user 510, as will be discussed in further detail below.

As previously discussed, items can communicate with each other in a variety of ways (e.g., over NFC, a WiFi network of the user 510, a home beacon of the user). Items can communicate with each other to recognize each other, as well as to recognize the user 510 with which the items are associated. In some embodiments, an item can recognize the user 510 via a camera on the item, via a fingerprint of the user 510 obtained via the item, via a passcode of the user 510 obtained via the item, and/or through radio frequency identification (ID) of the item.

The master item(s) of the user 510, such as first cell phone 520, can be used to coordinate the communication between all items of the user 510. A different implementation could involve all the items being able to communicate with each other and have each device ID of the corresponding item pushed to the neglected item system 400, or any of its modules, via one of the items having a corresponding application installed on it (e.g., a smartphone having a mobile application comprising the neglected item system 400 or a mobile application that communicates with the neglected item system 400 remotely). When a new item is purchased by the user 510, the new item can be detected by one of the other items, such as the master item, and added to the item inventory of the user 510.

If the user 510 purchases a new item that's a smart device, when that new item comes into the smart device network of the other items of the user 510, the smart items can identify the user 510 of the new item. The neglected item system 400 can exchange information with the new item to discover if there are any user profiles, e-mail addresses, phone numbers, or some other piece of data which can be used by the neglected item system 400 to identify that the new item is for a particular user. In the case of a new smartphone replacing a user's existing smartphone, the number associated with the new smartphone or the smartphone's device ID can be detected by a service (e.g., item inventory module 410) of the neglected item system 400. The service can make an API call to an identity service of a telecommunications service provider (e.g., AT&T®) to match the phone number or device ID. Additionally, the service can check the phone number or service provider account billing address against an existing profile of the user 510 to find a match. The service can also access the user's payment service (e.g., PayPal®) history to determine if the device ID or phone number of the new item exists on a payment service transaction or receipt (e.g., if the user 510 used a PayPal® account at an AT&T® store to purchase a phone upgrade). Other embodiments are also within the scope of the present disclosure.

Referring back to FIG. 4, neglected item identification module 420 can be configured to identify one or more items in the item inventory of a user as being neglected based on a determination of a lack of usage of the item(s). The neglected item identification module 420 can be configured to determine a lack of usage of one or more items of a user. This determination can be made in a variety of ways and be based on a variety of one or more factors.

In some embodiments, the lack of usage of an item can be determined based on a determination that the item has not been located within a specified proximity of a master item for a predetermined period of time. For example, referring to FIG. 5, it can be determined (e.g., by the neglected item identification module 420) that the second cell phone 540 has not been located within a specified proximity 560 (e.g., within 2 feet) of the first cell phone 520 (which can be selected and/or recognized as the master device) within a predetermined amount of time (e.g., 30 days). Since the first cell phone 520 (as the master device) can be assumed to typically be located very close to the user 510, it can be inferred that the lack of proximity of the second device 540 to the first cell phone 520 represents a lack of proximity of the second device 540 to the user 510, which can lead to the inference that the user 510 has not used the second cell phone 540 within the predetermined amount of time. This inference can be recognized as a lack of usage of the second cell phone 540.

In some embodiments, the lack of usage of an item can be determined based on a determination that the item has remained in a location for a predetermined period of time. For example, it can be determined that the second cell phone 540 has remained in the same location (e.g., within a 4 square foot area) for a predetermined period of time (e.g., 30 days). Based on an assumption that the second cell phone 540 is the type of item (e.g., a mobile device) that is typically moved around outside of the same location within the predetermined period of time when it has been used, it can be determined that the second cell phone 540 has not been used based on the determination that it has remained in the same location for that predetermined period of time.

It is contemplated that the location of items can be determined and monitored using a variety of positioning techniques, including, but not limited to, the use of global positioning system (GPS) technology.

In some embodiments, the lack of usage of an item can be determined based on a determination that the item has been in a non-operational mode for a predetermined period of time. For example, it can be determined that the printer 530 has been in an energy-saving mode or a power-off mode for a predetermined period of time (e.g., 90 days). Based on the determination of the printer 530 in a non-operational mode for the predetermined period of time, it can be determined that the printer 530 has not been used in that predetermined period of time. The neglected item identification module 420 can make this determination of an item being in a non-operational mode in a variety of ways, including, but not limited to, based on a lack of a response by the item to a response-requesting communication (e.g., the item being pinged).

In some embodiments, the lack of usage of an item can be determined based on a determination that the item has not performed a specific user-requested task or set of tasks for a predetermined period of time, or based on a determination that the item has not performed any user-requested tasks for a predetermined period of time. For example, it can be determined that the printer 530 has not performed any printing tasks for a predetermined period of time (e.g., the last 60 days). Based on the determination of the printer 530 has not performed any printing tasks for the predetermined period of time, it can be determined that the printer 530 has not been used in that predetermined period of time, thus resulting in a lack of usage being determined for the printer 530. The neglected item identification module 420 can make this determination of an item not performing a specific task, a specific set of tasks, or any tasks for a predetermined period of time in a variety of ways, including, but not limited to, accessing a log of activity of the item maintained on the item or on another device that monitors the use of the item.

In some embodiments, the determination of the lack of usage of an item of the user 510 can be based on a comparison of current usage information of the item with older historical usage information of the item by the user 510. Any of the threshold usage factors discussed herein (e.g., specified proximity, predetermined period of time) for determining a lack of usage of an item can be determined based on historical usage pattern information of the item by the user 510. For example, it can be determined that the printer 530 has not been used by the user 510 for the last 91 days. In determining whether this gap in usage constitutes a lack of usage upon which a determination of the item as being neglected should be made, the neglected item identification module 420 can determine the appropriate threshold for the predetermined period of time upon which this determination should be made by analyzing the user's previous pattern of usage of the printer 530. This information can be stored and retrieved from database(s) 450. The user's previous historical usage pattern information can indicate that, prior to the last 91 days, the user 510 used the printer at least once every 50 days. Based on the user's current gap of usage for the printer 530 exceeding the user's previous gap of usage for the printer of 50 days, a determination of a lack of usage for the printer 530 can be made, upon which an identification of the printer 530 as being neglected can be made.

In some embodiments, the determination of the lack of usage of an item of the user 510 can be based on a comparison of usage information of the item with usage information of at least one other item of at least one other user. Any of the threshold usage factors discussed herein (e.g., specified proximity, predetermined period of time) for determining a lack of usage of an item can be determined based on corresponding usage factors of at least one other item of at least one other user. For example, it can be determined that the printer 530 has not been used by the user 510 for the last 91 days. In determining whether this gap in usage constitutes a lack of usage upon which a determination of the item as being neglected should be made, the neglected item identification module 420 can determine the appropriate threshold for the predetermined period of time upon which this determination should be made by analyzing usage information of other printers. This information can be stored and retrieved from database(s) 450. Usage information of other printers may reflect that the average printer, when not forgotten or otherwise neglected, is used at least once every 80 days. Based on the gap of usage for the printer 530 exceeding the average gap of usage for printers of 80 days, a determination of a lack of usage for the printer 530 can be made, upon which an identification of the printer 530 as being neglected can be made. In some embodiments, the other item(s) of which the usage information is being compared to have been selected based on the other item(s) having been determined to meet a predetermined threshold of similarity with the item for which the lack of usage is being determined. For example, the other item(s) may be selected based on their being of the same make or model as the item for which the lack of usage is being determined. In some embodiments, the other item(s) have been selected also based on the other item(s) belonging to other user(s) determined to meet a predetermined threshold of similarity with the user 510. For example, the other items may be selected based on their belonging to users having an age within 5 years of the age of the user 510.

In some embodiments, certain items may be determined to have certain usage patterns that can be taken into consideration in the determination of a lack of usage. For example, although the volleyball 550 may not have been used within the last 3 months, the fact that it is February and the user 510 lives in a region associated with cold weather can prevent the volleyball 550 from being determined to be neglected. In some embodiments, the lack of usage determination for an item can be prevented or delayed based on a classification (e.g., seasonal item, sporadically used item) of the item, as well as on profile information (e.g., location/region of residence, age) of the user 510 associated with the item. The classification information of an item and the profile information of a user 510 can be stored and retrieved from database(s) 450.

Although certain items of the user 550 may be non-electronic items, such as the volleyball 550, a device such as an RFID tag can be coupled to the non-electronic item in order to enable usage of the non-electronic item to be monitored, such as by monitoring the location of the non-electronic item.

In addition to the usage factors discussed herein, other usage factors can also be used in the determination of a lack of usage for an item.

Notification module 430 can be configured to provide a notification to the user 510 based on the identifying of an item as being neglected. The notification can be provided in a variety of ways, including, but not limited to, within an e-mail message, within a text message, within a web page, and within a mobile application.

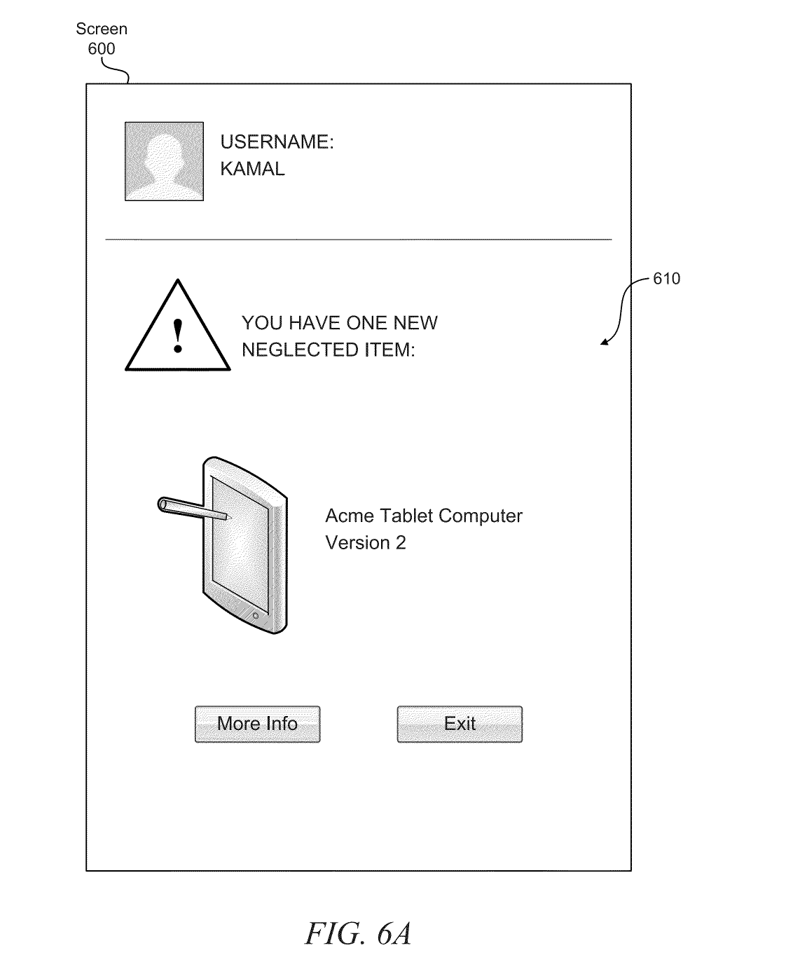

FIG. 6A illustrates a screen 600 (e.g., a display screen of a mobile device) displaying a notification 610 regarding a neglected item, in accordance with some embodiments. The notification 610 can comprise an identification of the user 510 (e.g., Kamal), a statement explaining that the user 510 has a neglected item (e.g., “YOU HAVE ONE NEW NEGLECTED ITEM:”), and an identification of the item, such as the name of the item (e.g., “Acme Tablet Computer”) and/or an image of the item. The notification 610 can also comprise a selectable user interface element (e.g., a “More Info” button) to enable the user 510 to view more information about the neglected item.

FIG. 6B illustrates the screen 600 displaying another notification 620 providing more information regarding the neglected item, in accordance with some embodiments. The notification 620 can provide an indication of usage information upon which the determination of the item as being neglected was based (e.g., “YOUR ITEM WAS LAST DETECTED AT THE FOLLOWING LOCATION 2 DAYS AGO:”), as well as location information of the item, such as an address and/or a map of where the item was last detected. In FIG. 6B, the notification 620 comprises a map of where the item was last detected along with an identification of the location of last detection as “Kamal's House.” In some embodiments, the user 510 can view more information about the location of the item by selecting or otherwise activating a user interface element in the notification 620.

FIG. 6C illustrates the screen 600 displaying yet another notification 630 providing further information regarding the location of the neglected item, in accordance with some embodiments. The notification 630 can comprise a precise location of the item within a structure, such as a precise location within the house of the user 510. In some embodiments, the notification 630 can also comprise a recommendation to list the item for sale on an online service. The notification 630 can comprise a selectable user interface element (e.g., a “Sell Item” button) that enables the user 510 to trigger the beginning of an automated guided process (e.g., a wizard) for selling the neglected item on an online marketplace.

Item listing module 440 can be configured to determine item listing information for the item, and to pre-populate at least one item listing field with the determined item listing information. The pre-populated item listing field(s) can then be provided to the user 510 for listing the item for sale. In some embodiments, the item listing information is determined based on point of sale data for the item (e.g., purchase data from the user 510 purchasing the item). In some embodiments, identification information of the item (e.g., product ID or MAC address) that was obtained by the item inventory module 410 when the item was added to the item inventory can be used to look up the appropriate item listing information from an online service (e.g., from on the online marketplace on which the item listing will be posted). In some embodiments, the item listing information can determined based on corresponding item listing information of at least one other item. The other item(s) can comprise an identical product as the item or a product that meets a threshold level of similarity with the item.

FIG. 6D illustrates a screen 600 displaying item listing fields 640 pre-populated with corresponding item listing information, in accordance with some embodiments. In some embodiments, the item listing information comprises at least one of a category for the item (e.g., “Computers/Tablets & Networking”), a name or title for the item (e.g., “Acme Tablet Computer V.2”), a description for the item (e.g., “1.2 GHz Dual Core processor, 7.0” Screen (1024×600), microSD Card Slot, 1 GB RAM & 8 GB on-board memory, Wi-Fi, 802.11 b/g/n 2.4 GHz, GPS, Bluetooth, USB 2.0, Built-in Mono Speakers, 2MP Rear Camera”), a price for the item (e.g., “68.75”), and an image of the item. Other types of item listing information are also within the scope of the present disclosure.

The item listing module 440 can enable the user 510 to edit the pre-populated item listing fields, making corrections and/or adding information to empty item listing fields, and to submit the item listing for posting on an online service to sell the item.

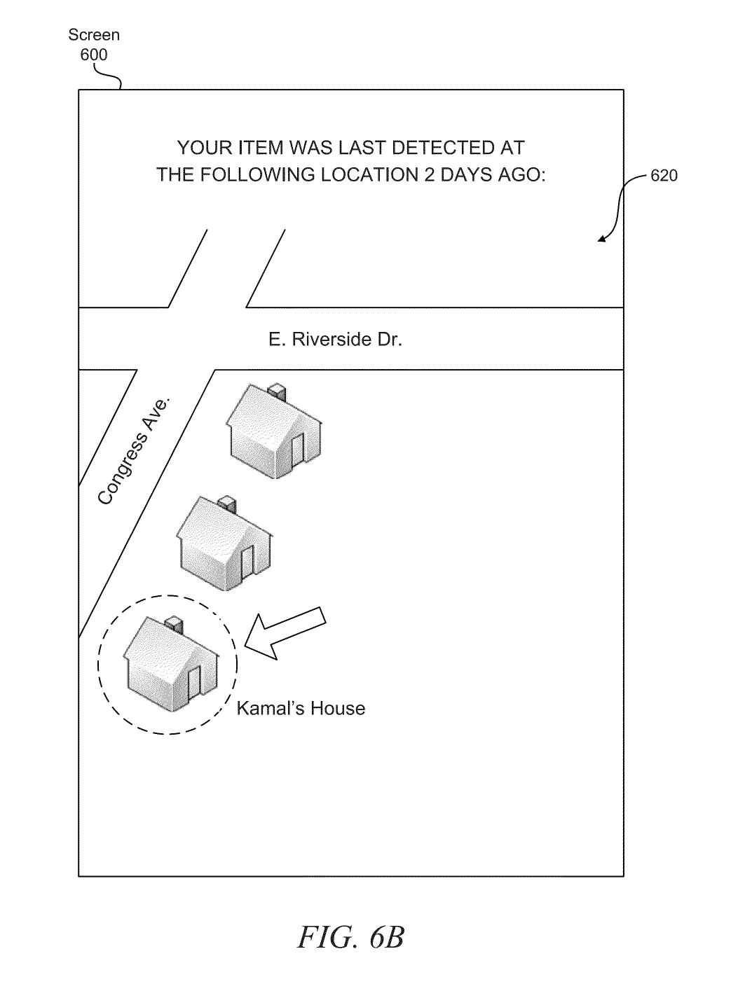

FIG. 7 is a flowchart illustrating a method 700 of recognizing neglected items, in accordance with some embodiments. The operations of method 700 may be performed by a system or modules of a system (e.g., neglected item system 400 in FIG. 4). At operation 710, an item inventory of a first user can be managed. The item inventory can comprise a plurality of user items including a first item. At operation 720, a lack of usage of the first item can be determined. At operation 730, the first item of a first user can be identified as being neglected based on the determination of the lack of usage of the first item. At operation 740, a notification can be provided to the first user based on the identifying of the first item as being neglected. The notification can comprise an identification of the first item. At operation 750, one or more pre-populated item listing fields for listing the first item for sale can be provided to the first user. It is contemplated that the operations of method 700 may incorporate any of the other features disclosed herein.

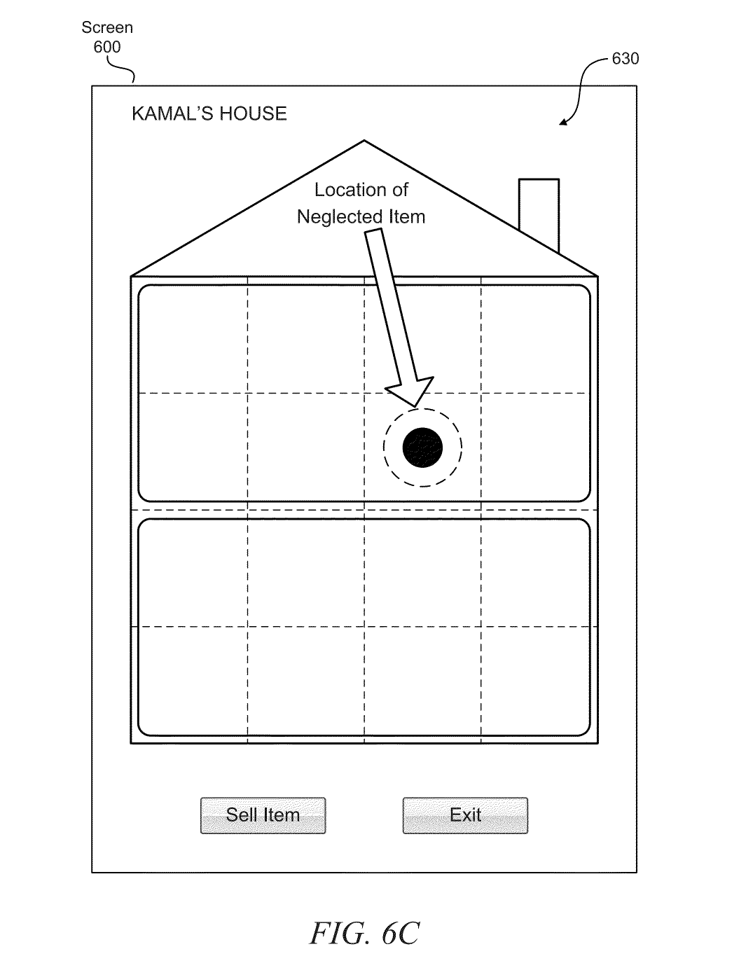

FIG. 8 is a flowchart illustrating a method 800 of managing an item inventory of a user, in accordance with some embodiments. The operations of method 800 may be performed by a system or modules of a system (e.g., neglected item system 400 in FIG. 4). At operation 810, an indication of an acquisition of a second item by the first user can be received. In some embodiments, receiving the indication comprises receiving purchase data of the second item. In some embodiments, receiving the indication comprises detecting a use of the second item in association with the first user. At operation 820, the second item can be added to the item inventory of the first user. It is contemplated that the operations of method 800 may incorporate any of the other features disclosed herein.

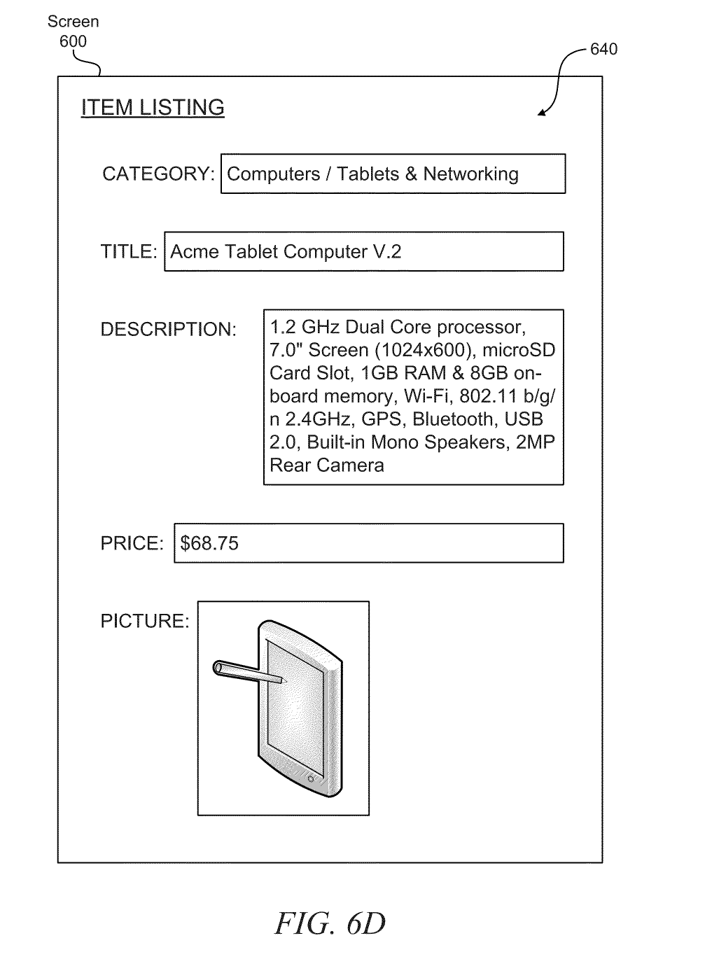

FIG. 9 is a flowchart illustrating a method 900 of determining a lack of usage of an item, in accordance with some embodiments. The operations of method 900 may be performed by a system or modules of a system (e.g., neglected item system 400 in FIG. 4). At operation 910, a determination can be made that a first item has not been located within a specified proximity of a master item for a predetermined period of time. At operation 920, a lack of usage of the first item can be determined based on the determination that the first item has not been within the specified proximity of the master item for the predetermined period of time. It is contemplated that the operations of method 900 may incorporate any of the other features disclosed herein.

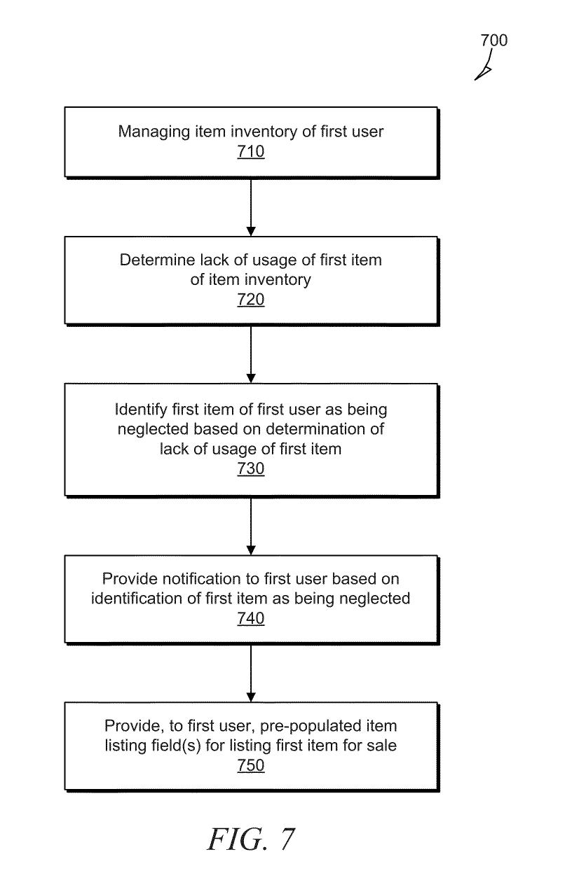

FIG. 10 is a flowchart illustrating a method 1000 of determining a lack of usage of an item, in accordance with some embodiments. The operations of method 1000 may be performed by a system or modules of a system (e.g., neglected item system 400 in FIG. 4). At operation 1010, a determination can be made that a first item has remained in a location for a predetermined period of time. At operation 1020, a lack of usage of the first item can be determined based on the determination that the first item has remained in the location for the predetermined period of time. It is contemplated that the operations of method 1000 may incorporate any of the other features disclosed herein.

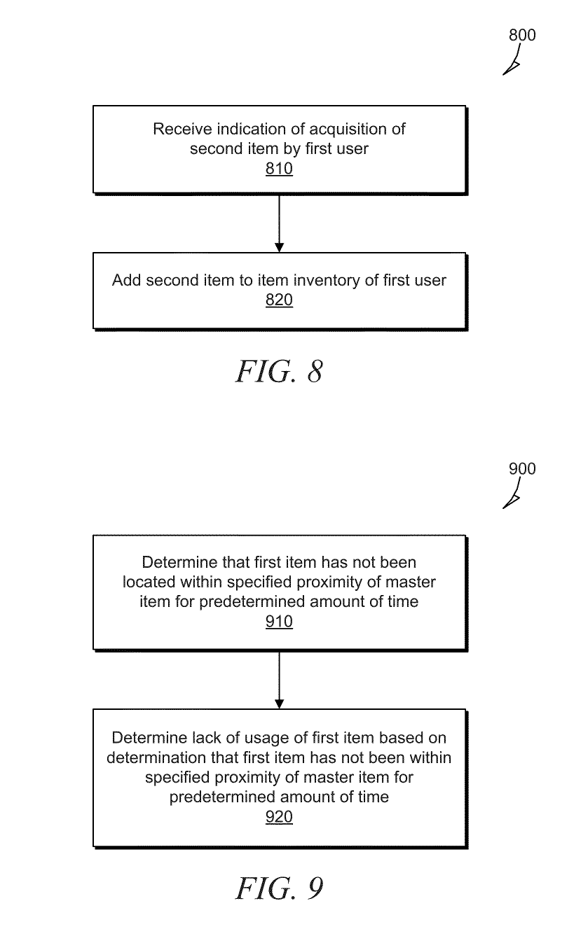

FIG. 11 is a flowchart illustrating a method 1100 of determining a lack of usage of an item, in accordance with some embodiments. The operations of method 1100 may be performed by a system or modules of a system (e.g., neglected item system 400 in FIG. 4). At operation 1110, a determination can be made that a first item has been in a non-operational mode for a predetermined period of time. The non-operational mode can comprise an energy-saving mode or a power-off mode. At operation 1120, a lack of usage of the first item can be determined based on the determination that the first item has been in a non-operational mode for the predetermined period of time. It is contemplated that the operations of method 1100 may incorporate any of the other features disclosed herein.

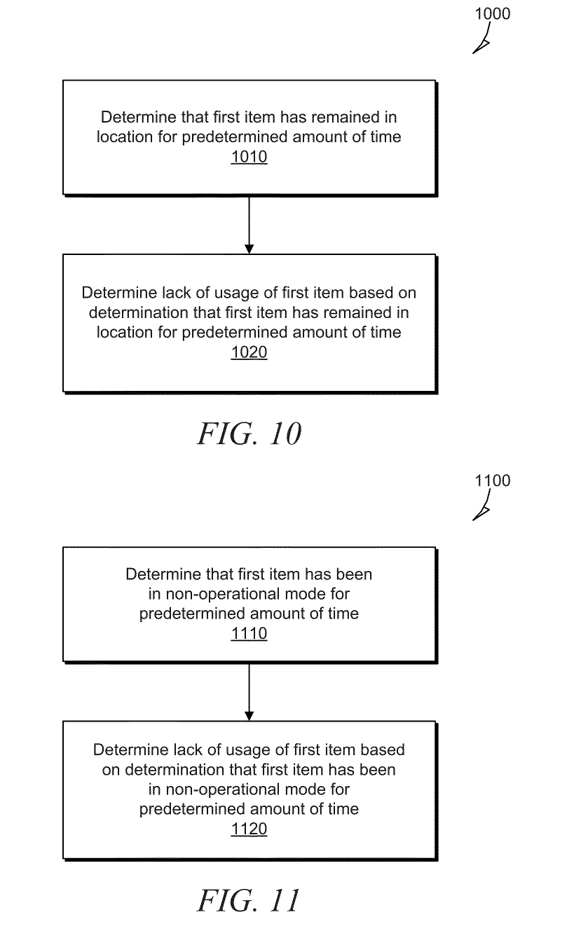

FIG. 12 is a flowchart illustrating a method 1200 of determining a lack of usage of an item, in accordance with some embodiments. The operations of method 1200 may be performed by a system or modules of a system (e.g., neglected item system 400 in FIG. 4). At operation 1210, a determination can be made that a first item has not performed a user-requested task for a predetermined period of time. At operation 1220, a lack of usage of the first item can be determined based on the determination that the first item has not performed a user-requested task for a predetermined period of time. It is contemplated that the operations of method 1200 may incorporate any of the other features disclosed herein.

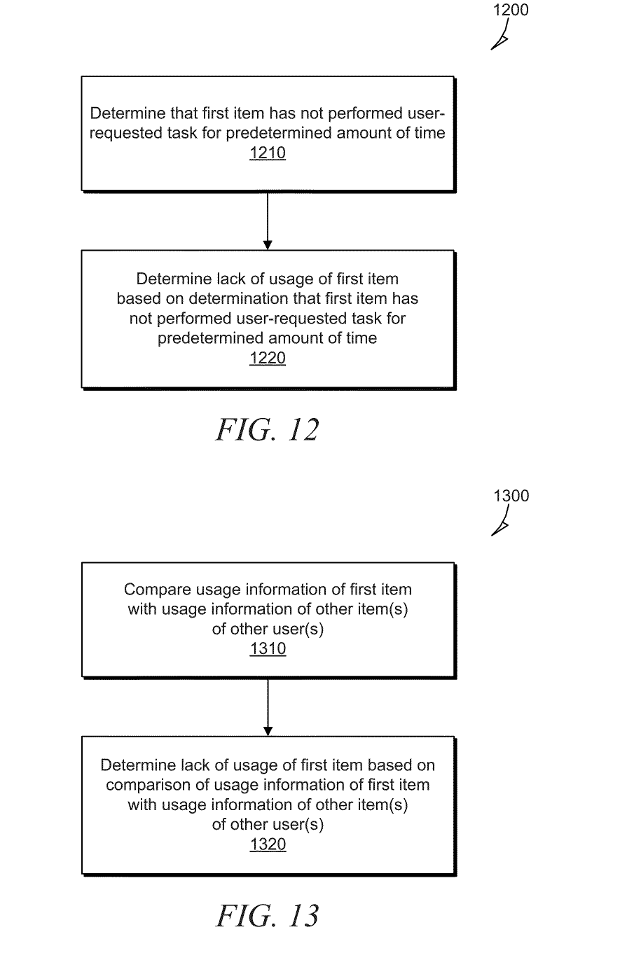

FIG. 13 is a flowchart illustrating a method 1300 of determining a lack of usage of an item, in accordance with some embodiments. The operations of method 1300 may be performed by a system or modules of a system (e.g., neglected item system 400 in FIG. 4). At operation 1310, usage information of a first item of a first user can be compared with one or more other items of one or more other users. At operation 1320, a lack of usage of the first item can be determined based on the comparison of the usage information of the first item with usage information of the other item(s) of the other user(s). It is contemplated that the operations of method 1300 may incorporate any of the other features disclosed herein.

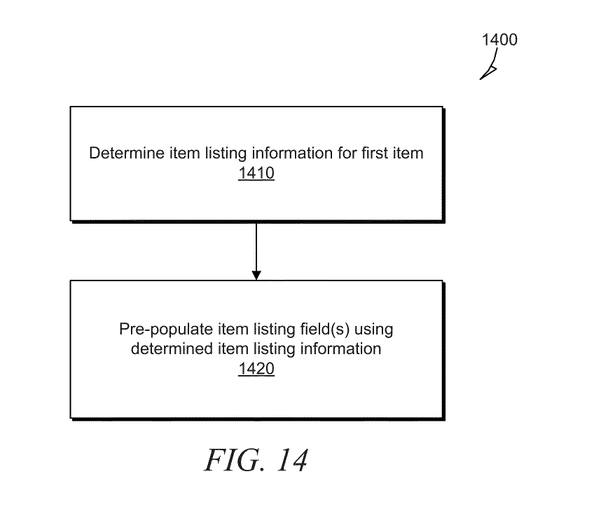

FIG. 14 is a flowchart illustrating a method 1400 of providing one or more pre-populated item listing fields for listing a neglected item for sale, in accordance with some embodiments. The operations of method 1400 may be performed by a system or modules of a system (e.g., neglected item system 400 in FIG. 4). At operation 1410, item listing information can be determined for a first item of a first user. Item listing information can include, but it not limited to, a category of an item, a title or name of an item, a description of an item, a price of an item, and a picture of an item. Other types of item listing information are also within the scope of the present disclosure. At operation 1420, one or more item listing fields can be pre-populated using the determined item listing information (e.g., as previously described with respect to FIG. 6D). It is contemplated that the operations of method 1400 may incorporate any of the other features disclosed herein.

The following use cases are provided by way of example only. It is contemplated that other use cases and other embodiments are within the scope of the present disclosure.

In one use case, a user may buy a new tablet computer at a store using a payment service (e.g., PayPal®) app on his smartphone, and then take the tablet home. The user may have allowed his payment service app to share information with an online marketplace (e.g., eBay®) app on his smartphone. The user can turn the tablet computer on, and the tablet computer can connect to the user's local network to download updates. The service provided by the neglected item system 400 can recognize the new tablet computer on the user's WiFi network. The service can make an API call to the tablet computer (e.g., a general “please identify yourself” API call), which can reveal the username currently on the tablet computer and its device ID. If the location of the tablet computer (e.g., determined via GPS and/or WiFi) is a location which is considered one of the user's “home locations”, and if the username/password on the tablet computer is one which is used by the user on different devices, or if the tablet computer's device ID can be discovered from analyzing the payment service transaction in which the user purchased the tablet computer, the service can consider the tablet computer as belonging to the user and add it to the user's item inventory.

The user can also have an older tablet computer, which he used consistently until purchasing the new tablet computer. The old tablet computer may remain on the user's bookshelf, unused. The service of the neglected item system 400 can recognize all the devices entering and exiting the user's home (e.g., via a home beacon), as well as all the devices which are interacting with the user at any given point in time. The user's devices may be next to the user's smartphone (his master device), or in the case of the user's old tablet computer, Kamal's passcode and device ID can be known to the service (e.g., via data sharing between the service and the tablet computer's OS). The device ID of the user's tablet computer may have been last seen on the user's WiFi network, his home's beacon, etc. before the tablet computer was powered down. Before a smart device powers down, it may push out a signal to the beacon in the user's home to provide notification that it is shutting down. The beacon can receive the shutdown signal and pass that information to the master device—in this case, the user's smartphone. Since the user's smartphone is running the service, the service can pick up this information that the user's old tablet computer was in the house while it was powered down. The old tablet computer can continue to be in a powered-down state (or in a semi-powered-down state where it can still send/receive network packets to indicate that it is still in sleep mode or some other non-operational mode), not being powered on or used by the user (e.g., not being brought into proximity of a master device, not being logged into using the user's profile), and can continue to be in approximately the same location (e.g., in a bookcase in the house of the user). The tablet computer isn't being powered on or used by Kamal (e.g.: it's not near his master device, logged into using Kamal's profile, etc). The service of the neglected item system 400 can recognize that a few weeks have gone by without the user using the old tablet computer, which the user previously used daily. The service can recognize that the user's behavior patterns regarding the tablet computer have changed. The service can also recognize that the old tablet computer's location has remained unchanged.

The service can create a “stock” item listing based on the device ID and other information gathered from the tablet computer during the user's use (e.g., item name, manufacturer, serial number, etc). The service can alert Kamal on the current device Kamal is using (or maybe just his master device) that it has noticed that the user has not used the old tablet computer in a few weeks. The service can ask the user if he or she would like to use the stock item listing to post the old tablet computer for sale on an online marketplace. The user may realize that he or she forgot to list the old tablet computer for sale after getting the new tablet computer. The user may elect to list the old tablet computer on the online marketplace using the stock item listing provided by the service of the neglected item system 400. As a result, the user is happy that the service realized a change in his usage patterns of the tablet computer and took the liberty of pre-populating a listing for his old tablet computer. The online marketplace is happy that the service has uncovered a neglected item that can be sold using its services.

In another use case, the service of the neglected item system 400 can recognize unused non-digital goods through the seasons. Here, the user buys a brand new volleyball at the sporting goods store which has an RFID tag on it. The user may have paid for the volleyball using his or her payment service (e.g., PayPal®) app on a smartphone (or other mobile device) of the user. The payment service understands the product the user has purchased when the product was scanned and paid for at the point-of-sale terminal. The user is able to synchronize the volleyball with the user's master device (e.g., the user's smartphone) using an application of the neglected item system 400. The user may have authorized the payment service and the application of the neglected item system 400 to exchange information.

Every time the volleyball comes within a specified proximity of the user's master device, the service recognizes the volleyball as “being used”. The service can notice that the user typically uses the volleyball during the Spring and Summer seasons. The service can compare the user's usage patterns against other users who have synchronized similar non-digital goods with their corresponding master devices and see when the items are being used. The service can notice that during an unseasonably warm Winter day, many users are playing with their volleyballs (e.g., coming in close proximity of them), while the user is noticed to not be in contact with his volleyball. The last recorded location of the user's volleyball may have been the user's house (e.g., in the garage). The service can notice that the user did not play volleyball on a day when other users did. When Spring arrives, the service can notice that people are using their synchronized, RFID volleyballs next to their smartphones (or other master devices). The user is noticed to still not be using his volleyball. The service can determine that, based on the user's previous volleyball season habits, and comparing against other users with similar products, the user is most likely not interested in playing volleyball anymore. The service can then pre-populate a stock item listing based on the payment service transaction information from when the user originally scanned and paid for the volleyball with his payment service application. The service can then provide a notification to the user that he might be interested in listing his unused volleyball, along with the pre-populated stock item listing.

As previously mentioned, the use cases above are provided merely as examples. It is contemplated that variations on these use cases, as well as completely different use cases, are within the scope of the present disclosure.

It is contemplated that any features of any embodiments disclosed herein can be combined with any other features of any other embodiments disclosed herein. Accordingly, these any such hybrid embodiments are within the scope of the present disclosure.

### Example Mobile Device

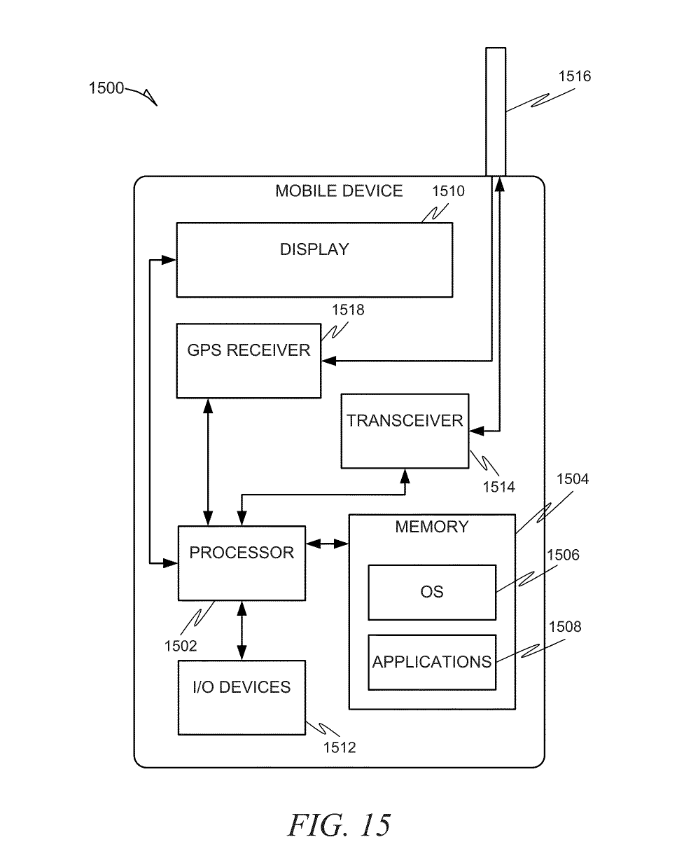

FIG. 15 is a block diagram illustrating a mobile device 1500, according to an example embodiment. The mobile device 1500 can include a processor 1502. The processor 1502 can be any of a variety of different types of commercially available processors suitable for mobile devices 1500 (for example, an XScale architecture microprocessor, a Microprocessor without Interlocked Pipeline Stages (MIPS) architecture processor, or another type of processor). A memory 1504, such as a random access memory (RAM), a Flash memory, or other type of memory, is typically accessible to the processor 1502. The memory 1504 can be adapted to store an operating system (OS) 1506, as well as application programs 1508, such as a mobile location enabled application that can provide LBSs to a user. The processor 1502 can be coupled, either directly or via appropriate intermediary hardware, to a display 1510 and to one or more input/output (I/O) devices 1512, such as a keypad, a touch panel sensor, a microphone, and the like. Similarly, in some embodiments, the processor 1502 can be coupled to a transceiver 1514 that interfaces with an antenna 1516. The transceiver 1514 can be configured to both transmit and receive cellular network signals, wireless data signals, or other types of signals via the antenna 1516, depending on the nature of the mobile device 1500. Further, in some configurations, a GPS receiver 1518 can also make use of the antenna 1516 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

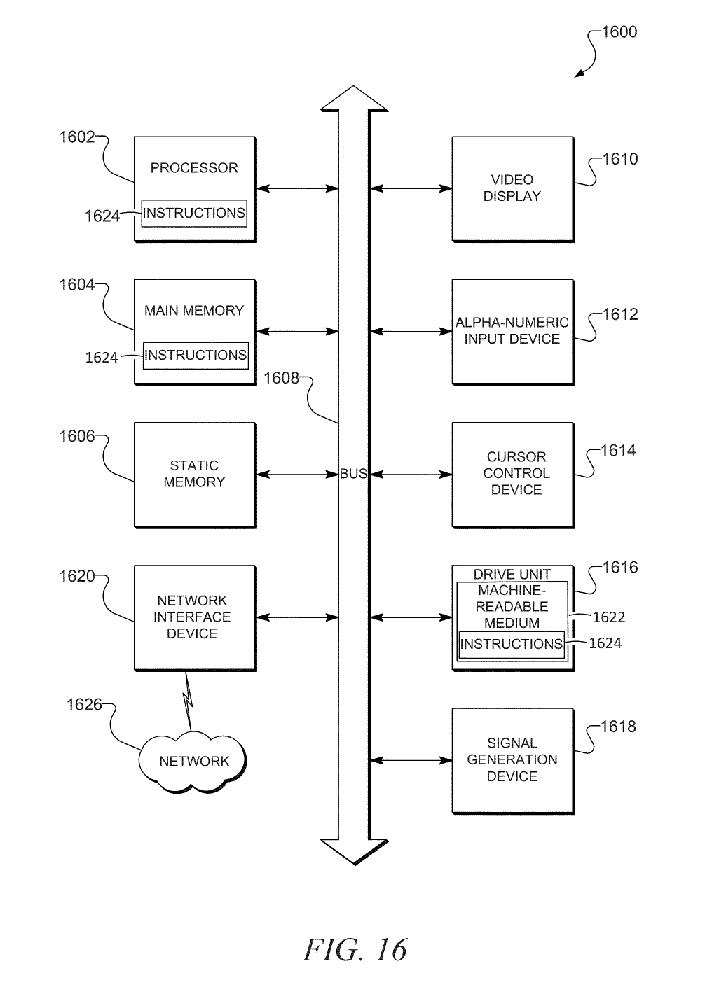

FIG. 16 is a block diagram of a machine in the example form of a computer system 1600 within which instructions 1624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation (or cursor control) device 1614 (e.g., a mouse), a disk drive unit 1616, a signal generation device 1618 (e.g., a speaker) and a network interface device 1620.

### Machine-Readable Medium

The disk drive unit 1616 includes a machine-readable medium 1622 on which is stored one or more sets of data structures and instructions 1624 (e.g., software) embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media. The instructions 1624 may also reside, completely or at least partially, within the static memory 1606.

While the machine-readable medium 1622 is shown in an example embodiment to be a single medium, the term “machine-readable medium” may include a single medium or multiple media (e.g., a centralized or distributed database, and/or associated caches and servers) that store the one or more instructions 1624 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
identifying, by a machine having a memory and at least one processor, a first item of a first user as being neglected based on a determination of a lack of usage of the first item; and
providing, to the first user, a notification based on the identifying of the first item as being neglected, the notification comprising an identification of the first item.

2. The method of claim 1, wherein the first item is an electronic device.

3. The method of claim 1, further comprising determining the lack of usage of the first item based on a determination that the first item has not been located within a specified proximity of a master item for a predetermined period of time.

4. The method of claim 1, further comprising determining the lack of usage of the first item based on a determination that the first item has remained in a location for a predetermined period of time.

5. The method of claim 1, further comprising determining the lack of usage of the first item based on a determination that the first item has been in a non-operational mode for a predetermined period of time, the non-operational mode comprising an energy-saving mode or a power-off mode.

6. The method of claim 1, further comprising determining the lack of usage of the first item based on a determination that the first item has not performed a user-requested task for a predetermined period of time.

7. The method of claim 1, wherein the determination of the lack of usage of the first item is based on a comparison of usage information of the first item with usage information of at least one other item of at least one other user.

8. The method of claim 7, wherein the at least one other item is determined to meet a predetermined threshold of similarity with the first item.

9. The method of claim 7, wherein the at least one other user is determined to meet a predetermined threshold of similarity with the first user.

10. The method of claim 1, wherein the notification further comprises a recommendation to list the first item for sale on an online service.

11. The method of claim 1, further comprising:
determining item listing information for the first item;
pre-populating at least one item listing field using the determined item listing information; and
providing the pre-populated at least one item listing field to the first user.

12. The method of claim 11, wherein the item listing information is determined based on point of sale data for the first item.

13. The method of claim 11, wherein the item listing information is determined based on corresponding item listing information of at least one other item, the at least one other item comprising an identical product as the first item.

14. The method of claim 11, wherein the item listing information comprises at least one of an item listing title, an item listing description, and an item listing price.

15. The method of claim 1, further comprising:
managing an item inventory of the first user, the item inventory comprising a plurality of user items including the first item;
for each user item in the item inventory, determining whether the user item is being neglected based on a determination of a lack of usage of the user item; and
for each user item determined to be neglected, providing, to the first user, a notification of the user item being neglected, the notification comprising an identification of the user item.

16. The method of claim 15, wherein managing the item inventory comprises:
receiving an indication of an acquisition of a second item by the first user; and
adding the second item to the item inventory.

17. The method of claim 16, wherein receiving the indication comprises receiving purchase data of the second item.

18. The method of claim 16, wherein receiving the indication comprises detecting a use of the second item in association with the first user.

19. A system comprising:
a machine having a memory and at least one processor; and
at least one module, executable by the at least one processor, configured to:
identify a first item of a first user as being neglected based on a determination of a lack of usage of the first item; and
provide, to the first user, a notification based on the identifying of the first item as being neglected, the notification comprising an identification of the first item.

20. A non-transitory machine-readable storage medium storing a set of instructions that, when executed by at least one processor, causes the at least one processor to perform a set of operations comprising:
identify a first item of a first user as being neglected based on a determination of a lack of usage of the first item; and
provide, to the first user, a notification based on the identifying of the first item as being neglected, the notification comprising an identification of the first item.
